(19) United States
(12) Patent Application Publication
(10) Pub. No.: US 2026/0180497 A1
(43) Pub. Date: Jun. 25, 2026

(54) Mounting Base for PV Panel Installation

(71) Applicant: Top Rack Technology, Inc., Moorestown, NJ (US)

(72) Inventor: Guohao Zhu, Haining City (CN)

(73) Assignee: Top Rack Technology, Inc., Moorestown, NJ (US)

(21) Appl. No.: 19/097,236

(22) Filed: Apr. 1, 2025

(30) Foreign Application Priority Data
Dec. 19, 2024 (CN) 202423133900.1

(51) Int. Cl. H02S 20/30

(52) U.S. Cl. CPC H02S 20/30

(57) ABSTRACT

The present disclosure relates to a mounting base designed for PV panel installation, comprising an integrated base body, multiple mounting screws, and rail clamps. This design incorporates pre-installed mounting screws and rail clamps within the mounting base, enabling workers to efficiently position and install the entire base at a predetermined location. The compact structure and innovative design streamline the installation process, significantly enhancing speed and efficiency.

### TECHNICAL FIELD

The present utility model relates to the field of solar photovoltaic (PV) technology, specifically to a mounting base for PV panel installation.

### BACKGROUND TECHNOLOGY

Currently, rooftop-mounted PV systems primarily consist of solar panels and mounting structures, with the panels being secured to the roof via PV mounting brackets. The conventional installation process involves first fixing a mounting base to the roof, followed by installing rails onto the base. However, this method requires multiple components, including mounting screws, specialized tools, and rail clamps, making the installation complex and time-consuming. Furthermore, the presence of numerous small parts increases the likelihood of misplacement, further extending the installation process.

### SUMMARY OF THE UTILITY MODEL

To address the limitations of existing technology, the present utility model provides a mounting base for PV panel installation with pre-installed mounting screws and rail clamps, allowing workers to position and install the entire base at a predetermined location with ease. This design ensures a compact structure, optimized design, and convenient installation, significantly improving installation speed and efficiency.

To achieve the above objectives, the present utility model provides a mounting base for PV panel installation, comprising:
An integrated base body, multiple mounting screws, and rail clamps.
The base body consists of a fixed base, which connects to the ground, and a mounting section, which connects to the rail clamps.
The fixed base is equipped with multiple pre-installed screw sections, arranged around its periphery, with pre-threaded holes matching the mounting screws.
The rail clamp consists of a clamp body and an adjustable section, which includes a movable block, a conical spring, and a flange bolt.
The mounting section features a positioning groove, while the clamp body is equipped with a protrusion that fits into the positioning groove, ensuring precise alignment during installation.

### Further Improvements

1. Bottom Layer Protection: The bottom of the fixed base is sequentially layered with a foam rubber layer, a butyl rubber layer, and release paper, enhancing vibration absorption and waterproofing.
2. Height Adjustability: The mounting section is designed in a U-shape, allowing for vertical height adjustment via a U-slot mechanism when connected to the rail clamps using bolts.
3. Enhanced Stability: The top of the mounting section is designed with a retaining edge to prevent bolt slippage.
4. Spare Mounting Hole: The center of the fixed base is provided with a spare screw installation hole for additional fastening options.
5. Anti-Slip Design: The contact surface between the mounting section and the rail clamp is equipped with anti-slip teeth to enhance stability.
6. Optimized Positioning Mechanism: The positioning groove and the protrusion are both rectangular, ensuring accurate alignment during assembly.

### Customization Options

The number of mounting screws can be adjusted to 3-5 as needed.
The rail clamps can be configured based on installation requirements and can be compatible with existing rail clamps.

### Advantages of the Utility Model

Pre-installed mounting screws and rail clamps simplify the installation process, reducing the number of individual components that need to be handled on-site.
The compact structure and well-designed layout allow for quick and efficient installation, minimizing labor time.
The adjustable and anti-slip features improve structural stability and durability.
The waterproof and vibration-absorbing layers enhance the longevity and reliability of the mounting base.

This mounting base for PV panel installation significantly improves installation efficiency, stability, and durability, making it an ideal solution for modern solar PV mounting systems.

### DESCRIPTION OF DRAWINGS

FIG. 1: Structural schematic diagram of the embodiment of the present utility model.

FIG. 2: Partial structural schematic diagram of the embodiment of the present utility model.

FIG. 3: Structural schematic diagram of the rail clamp in the embodiment of the present utility model.

FIG. 4: Installation schematic diagram of the rail clamp in the embodiment of the present utility model.

FIG. 5: Schematic diagram of the installed structure in the embodiment of the present utility model.

### ILLUSTRATION LABELS IN THE DRAWINGS

1—Fixed Base
2—Mounting Screw
3—Mounting Section
4—Pre—installed Screw Section
5—Retaining Edge
6—Foam Rubber Layer
7—Base Adhesive Layer
8—Release Paper
9—Rail Clamp
10—Clamp Body
11—Movable Block
12—Conical Spring
13—Flange Bolt
14—Protrusion
15—Groove
16—Spare Screw Installation Hole

### Detailed Description of the Embodiment

The following section, in conjunction with the accompanying drawings, provides a clear and complete description of the technical solutions of the embodiments of the present utility model. It is evident that the described embodiments represent only a portion of the possible implementations of this invention and not all possible embodiments. Based on the disclosed embodiments, any other implementations obtained by those skilled in the field without making creative efforts fall within the scope of the present utility model.

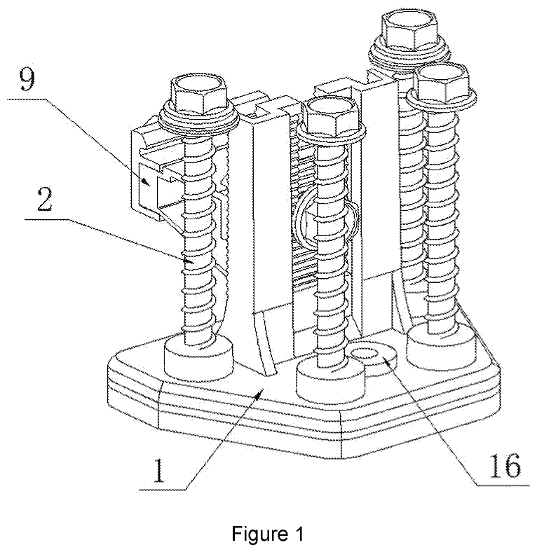

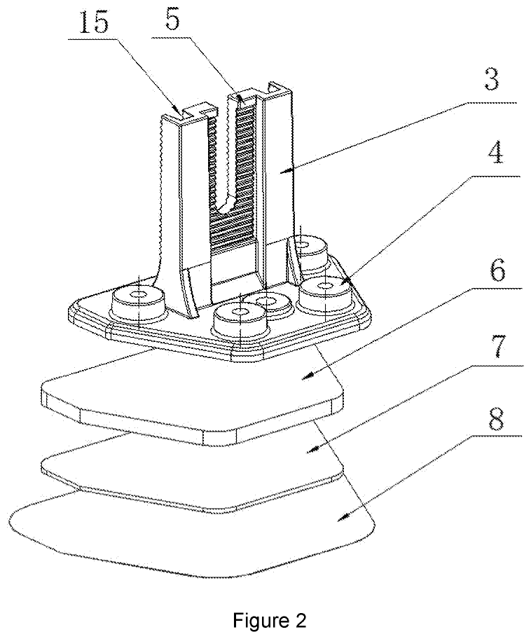

As shown in FIGS. 1, 2, and 5, a mounting base for PV panel installation is disclosed, comprising:
An integrated base body
Multiple mounting screws (2)
Rail clamps (9)

The base body includes:
A fixed base (1), which connects to the ground
A mounting section (3), which connects to the rail clamps (9)

The fixed base (1) is equipped with:
Multiple pre-installed screw sections (4), arranged around its periphery, with pre-threaded holes matching the mounting screws (2)
A spare screw installation hole (16) at the center of the fixed base (1)
A bottom layer structure, consisting of a foam rubber layer (6), a butyl rubber layer (7), and release paper (8) for vibration absorption and waterproofing

The mounting section (3) is:
U-shaped, allowing for vertical height adjustment via a U-slot mechanism when connected to the rail clamps (9) using bolts
Equipped with a rectangular positioning groove (15)
Designed with a rectangular protrusion (14) on the clamp body (10), ensuring secure positioning through matching engagement
Enhanced with anti-slip teeth at the contact interface between the mounting section (3) and the rail clamp (10)
Reinforced at the top with a retaining edge (5) to prevent bolt slippage

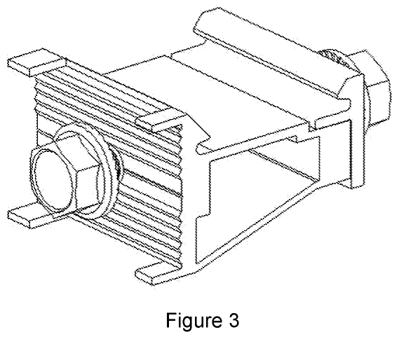

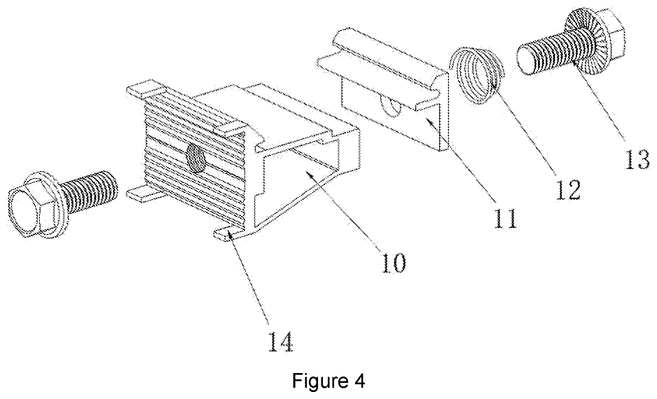

As shown in FIGS. 3 and 4, the rail clamp (9) comprises:
A clamp body (10)
An adjustable section, which includes:
   A movable block (11)
   A conical spring (12)
   A flange bolt (13)

### Installation Process

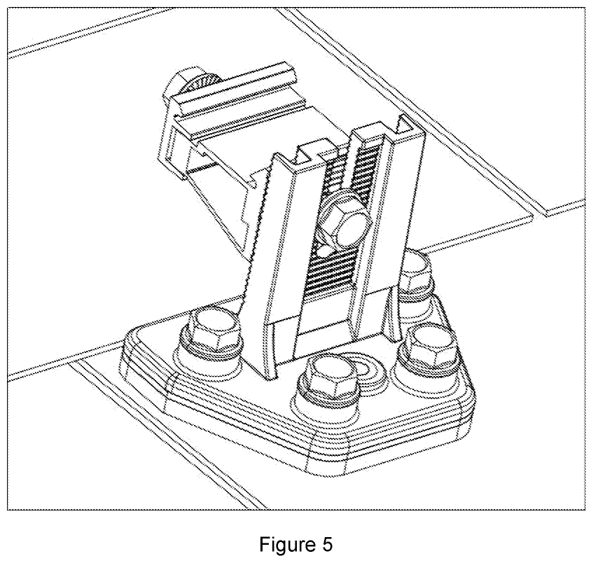

1. Preparing the Fixed Base:
   Remove the release paper (8).
   Adhere the fixed base (1) to the pre-determined installation point.
   Press gently and evenly to ensure the butyl rubber layer (7) adheres firmly to the roof while avoiding any tilted placement of the fixed base (1).
2. Securing the Mounting Screws:
   Install four mounting screws (2) in a diagonal sequence.
   Ensure the torque is neither excessive nor insufficient.
   Prevent misalignment of the mounting screws (2).
3. Adjusting the Rail Clamps:
   The rail clamp (9) is pre-assembled onto the U-shaped mounting section (3).
   Adjust the installation height based on the roof's flatness.
   Once adjusted, finalize the installation as shown in FIG. 5.
4. Installing the Rails:
   Once all mounting bases are installed, adjust the rail clamps (9) to the appropriate height for rail installation.
   Install the rails directly onto the rail clamps.
   The adjustable section in the rail clamp (9) allows for a certain degree of flexibility, ensuring easy and fast installation.

This mounting base design significantly improves the efficiency, durability, and safety of PV panel installations, ensuring secure attachment, structural stability, and reliable grounding.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A mounting base for PV panel installation, characterized in that it comprises an integrated base body, multiple mounting screws (2), and rail clamps (9), wherein:
the base body includes a fixed base (1) and a mounting section (3) on top of the fixed base, wherein the mounting section connects to the rail clamps (9);
the fixed base (1) is equipped with multiple pre-installed screw sections (4), arranged around its periphery, with pre-threaded holes matching the mounting screws (2);
the rail clamp (9) consists of a clamp body (10) connected to an adjustable section, wherein the adjustable section includes a movable block (11), a conical spring (12), and a flange bolt (13); and
the mounting section (3) features a positioning groove (15);
the clamp body (10) is equipped with a protrusion (14) that fits into the positioning groove (15).

2. The mounting base for PV panel installation according to claim 1, characterized in that the bottom of the fixed base (1) is sequentially layered with a foam rubber layer (6), a butyl rubber layer (7), and release paper (8).

3. The mounting base for PV panel installation according to claim 1, characterized in that the mounting section (3) is U-shaped, and the rail clamps (9) are connected to the mounting section (3) via bolts, allowing for vertical height adjustment through a U-slot mechanism.

4. The mounting base for PV panel installation according to claim 3, characterized in that the top of the mounting section (3) is designed with a retaining edge (5) to prevent bolt slippage.

5. The mounting base for PV panel installation according to claim 1, characterized in that the center of the fixed base (1) is provided with a spare screw installation hole (16).

6. The mounting base for PV panel installation according to claim 1, characterized in that a contact surface between the mounting section (3) and the rail clamp (10) is equipped with anti-slip teeth.

7. The mounting base for PV panel installation according to claim 1, characterized in that the positioning groove (15) and the protrusion (14) are both rectangular.
